(19) United States
(12) Patent Application Publication
(10) Pub. No.: US 2011/0254309 A1
(43) Pub. Date: Oct. 20, 2011

(54) EXTENSIBLY RETRACTABLE SUNVISOR EQUIPMENT

(76) Inventor: Gerhardus Johannes Cornelius Visagie, Midrand (ZA)

(21) Appl. No.: 13/129,067

(22) PCT Filed: Nov. 12, 2009
(86) PCT No.: PCT/ZA2009/000110

§ 371 Date: Jun. 9, 2011

(30) Foreign Application Priority Data
Nov. 12, 2008 (ZA) 2008/08287

(51) Int. Cl. B60J 3/02

(52) U.S. Cl. 296/97.6

(57) ABSTRACT

Extensibly retractable sun visor equipment (10) comprises a visor body (12) formed with an interior cavity (14) extending between facing sidewalls (16) that is open to the environment along a slot (18) extending fully along the bottom edge (40) of the visor body (12) and along its opposite lateral through the slot (18). A magnetic layout comprises a number of magnetic force providing element configurations (24) fitted to the panel (24) including magnets (52) incorporated within movement limiting stop blocks (28), and magnetically attracting sheets (26) extending inside the sidewalls (16). The magnetic force between the magnets (52) and the sheets (26) is adequately strong to generate sufficient magnetic and frictional resistance to hold the panel (20) in its selected position though still permitting its multi-directional manual adjustment.

### BACKGROUND TO THE INVENTION

Conventional sun visors perform their direct visual sunray exposure screening function under most conditions of driver exposure thereto. Owing to having been designed to accommodate persons of average size, conditions do arise where such visors cannot perform their screening functions. It is however not only under such conditions that such equipment fails to properly perform their screening functions. It may be that when sunlight comes through a side window the reach of the swivelled visor may be inadequate. This is also the case where the sun sits low on the horizon in front of a driver or driver exposure thereto is through a central unsceenable windscreen section. It is, amongst others, an object of this-invention to under driving conditions also accommodate such situations of direct exposure to the sun.

### FIELD OF THE INVENTION

This invention relates to vehicular employable sun visor type equipment for use in adjustably serving a direct visual sunray exposure mitigating function. While not so limited the invention finds particular use when in the form of extensibly retractable sun visor equipment.

### PRIOR ART DESCRIPTION

Adjustable sun visors are known in the prior art. Amongst the presently known equipment is also found that use extension panels that in some or other way have a sliding action relative to a main visor body. A problem experienced with such equipment is that their sliding parts tend to become displaced under driving conditions owing to not being held adequately tightly. This requires irritating and even dangerous intermitted re-adjustment. If, on the other hand, held adequately tightly the adjustment action may require too much effort to the extent of even jeopardising the driver's concentration.

Such known equipment furthermore does not cater for multiple direction adjustment relative to a sun visor body.

### BRIEF DESCRIPTION OF THE DRAWINGS

The invention is now described, by way of example, with reference to the accompanying drawings. In the drawings

FIG. 1 three dimensionally shows one embodiment of vehicular employable sun visor type equipment in the form of an extensibly retractable sun visor equipment that is multi-dimensionally adjustable,

FIG. 2 shows one variation of the FIG. 1 embodiment of the extensibly retractable sun visor equipment in sidewall removed frontal view,

FIG. 3 shows the sun visor equipment of FIG. 2 along section A-A in FIG. 2 though in full sun visor view,

FIG. 4 shows the sun visor equipment of FIG. 2 along section B-B in FIG. 2 also in full sun visor view,

FIG. 5 shows another variation of the FIG. 1 embodiment of the extensibly retractable sun visor equipment in inwardly stepped frontal view,

FIG. 6 shows the sun visor equipment of FIG. 5 along section C-C in FIG. 5 though in full sun visor view,

FIG. 7 in frontal view shows even another embodiment of the extensibly retractable sun visor equipment that is only linearly adjustable,

FIG. 8 in diagrammatic view in accordance with section line A-A in FIG. 2 shows yet another embodiment of the extensibly retractable sun visor equipment in the form of an accessory that is thus attachable to a conventional sun visor,

FIG. 9 in diagrammatic view in accordance with section line A-A in FIG. 2 shows even another embodiment of the extensibly retractable sun visor equipment in the form of an accessory that is thus attachable to a conventional sun visor, and

FIG. 10 diagrammatically shows a variety of positions that can be taken up by the extensibly retractable sun visor equipment of the FIGS. 1 to 6 embodiments.

### DETAILED DESCRIPTION OF THE DRAWINGS

Referring to the drawings, vehicular employable sun visor type equipment for use in adjustably serving a direct visual sunray exposure mitigating function in the form of an extensibly retractable sun visor equipment is generally indicated by reference numeral 10.

The equipment 10 comprises a visor body 12 formed with an interior spacing in the form of an interior cavity 14 formed between facing sidewalls 16 which form part of the visor body 12. Cavity 14 is open to the environment along an aperture in the form of a slot 18, as discussed in more detail below for the various embodiments. A displaceable visor function extender in the form of a displaceable panel 20 is slidably fitted along the cavity 14 and through the slot 18, and is manipulable via a manual extender displacer in the form of a pair of gripping strips 22. A magnetic layout comprising a magnetic facility and complementary magnetic means is provided by a number of magnetic force providing element configurations 24 and two sheets 26 of magnetically attracting material fitted inside the sidewalls 16 of the visor body 12.

The visor equipment 10 also includes a constraining arrangement in the form of a number of slide extent inhibitors provided by movement limiting stop blocks 28, each incorporating a magnetic force providing element configuration 24. The stop blocks 28 are fitted to opposite faces of the displaceable panel 20 and are constrained from leaving the cavity 14 as a result of the visor body 12 being formed with border providing lips 32 as discussed in more detail below for the various embodiments of the invention. The combination of displaceable panel 20 and fitted stop blocks 28 incorporating the magnetic force providing element configurations 24 together form a sliding unit 34.

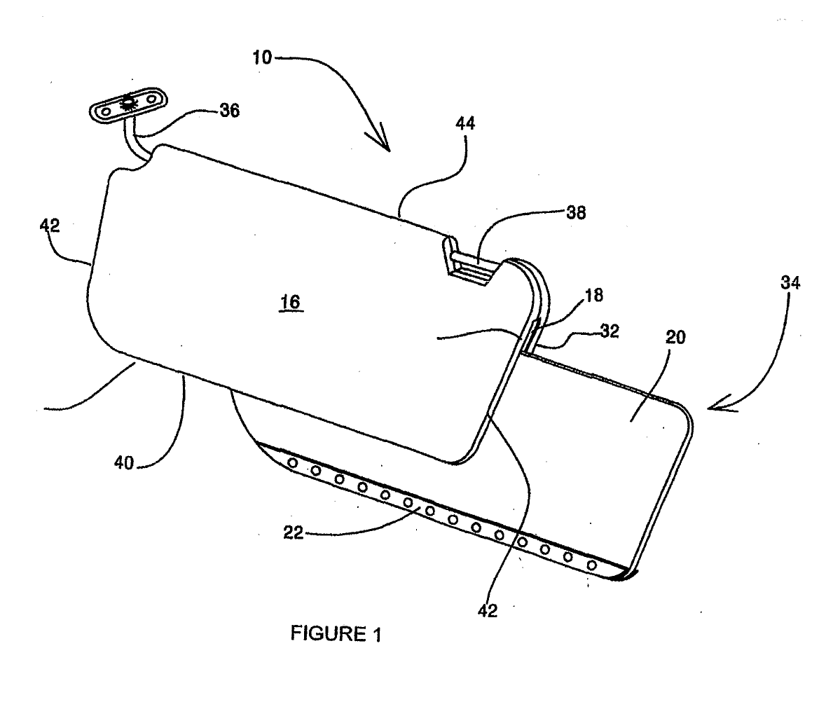

The visor equipment 10 of the FIGS. 1 to 7 embodiments, as in the case of an independent visor, is conventionally fitted with an attachment bracket 36 by means of which it is conventionally swivellably secured in its operative condition. It also has a clip engaging facility 38 by means of which it is conventionally secured to a windshield visor providing function vehicle-mounted clip (not shown) that is situated adjacent rear view mirror of such vehicle of which the function is to relieve the stress on the attachment bracket 36 once the equipment 10 is in use. Some vehicles are also provided with above the side window mounted clips to accommodate the weight of the visor equipment 10 when swivelled accordingly. When not so fitted the visor body 12 can be fitted with Velcro type attachment material (not shown) that is releasable securable to complementary and appropriately secured attachment material situated above the relevant side window.

The equipment 10 is made of fairly flexible materials capable of absorbing considerable impact to limit the infliction of injury under injury causing conditions.

Remaining with the FIGS. 1 to 6 embodiments, the slot 18 of the equipment 10 extends fully along the bottom edge 40 of the visor body 12 as well as upwards along the opposite lateral edges 42 up to a position adequately short of the upper edge 44 to facilitate the formation of an upper zone of firmness as provided by a bridging section 46. The bridging section 46 renders the sidewalls 16 of the visor body 12 adequately strong.

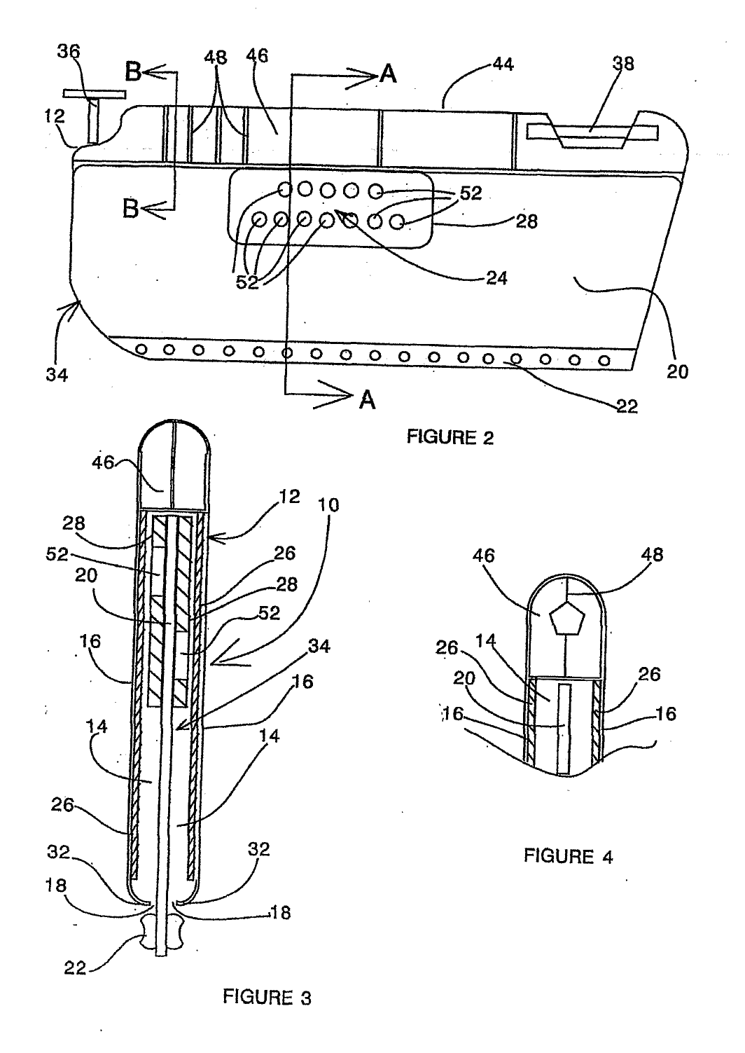

With particular reference to FIGS. 2 and 3, the stop-blocks 28 are suitably sized and shaped, as well as appropriately positioned and attached to the displaceable panel 20, to enable them to properly serve their panel release inhibiting functions in conjunction with the lips 32. The stop blocks 28 are preferably attached in a back-to-back fashion with the panel 20 interspaced between them. The zone of firmness can be in the form of a hollow bridging section 46 strengthened by strengthening ribs 48.

Each magnetic force providing element configuration 24 is in the form of a set of magnets each of which magnets 52 is fitted within a bore in its stop block 28. The magnets 52 are fitted so that their outer faces lie substantially flush with the faces of their surrounding stop blocks 28. The magnets 52 consequently exert a magnetic force on the sheets 26, pulling them up against the stop blocks 28. This force is adequately strong to generate sufficient magnetic and frictional resistance to hold the sliding unit 34 in its selected position. The total magnetic resistance to sliding of the sliding unit 34 at any particular time is augmented by the total frictional resistance to sliding developed between all relevant contacting surfaces which at that stage happen to be drawn or pressed together.

The magnets 52 can be fitted against relative displacement to their stop blocks 28. Otherwise they can be loosely held by their stop-blocks 28 thereby permitting their free displacement along their seating bores. In such case the stop blocks 28 fit with a slight clearance between themselves and the sheets 26 within the cavity 14. The magnets 52 thus engage with their sheets 26 in response to outward sliding along their bores. Owing to the small area of inter-engagement between the units 24 and the sheets 26, resistance to sliding is in such a case mainly dependent on magnetic force while relatively little frictional grip, if any, is developed between the sheets 26 and the sliding unit 34.

The stop blocks 28 can be formed with unoccupied magnet bores that can subsequently be used for fitting additional magnets under rough Operating conditions where additional magnetic resistance is required. The visor 10 can be formed to be capable of being opened up, thus permitting access to the stop blocks 28 for adding or removing magnets 52.

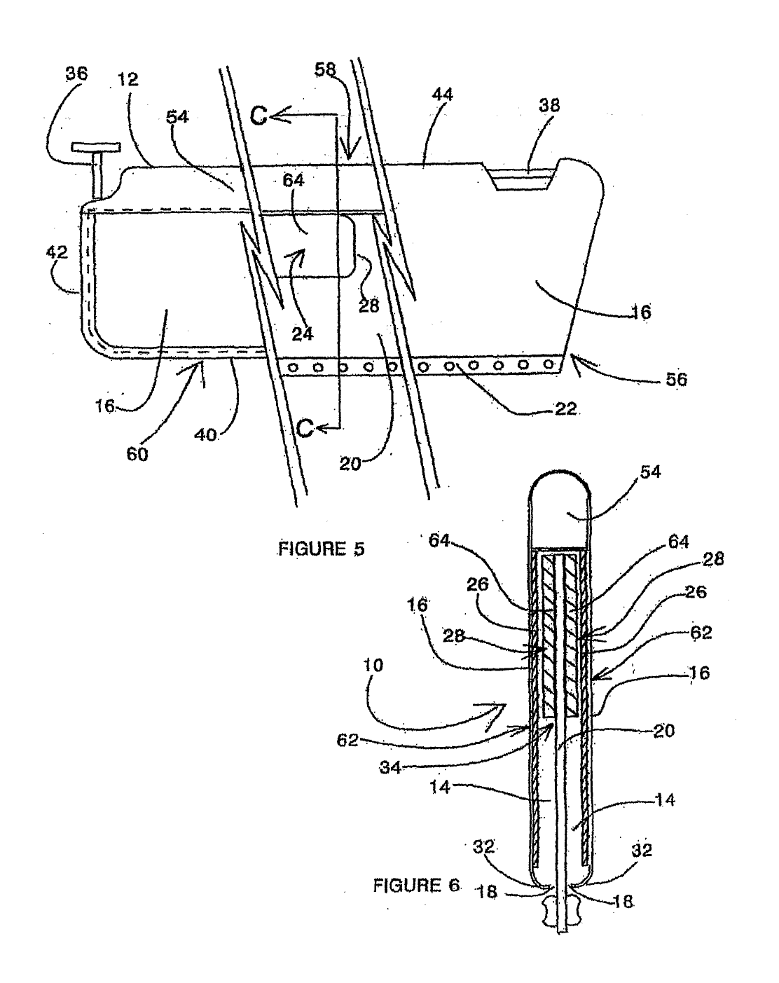

In another embodiment as shown in FIGS. 5 and 6, the sidewalls 16 are interconnected by a solid overhead bridging section 54. The three different frontal view elevations of FIG. 5 show the full external view under reference numeral 56, a sidewall removed view under reference numeral 58, and a sidewall and displaceable panel removed view under reference numeral 60. While not so limited, the visor body 12 is in this case constituted from a pair of mirror image body sections 62 that are simply fitted together to form the body 12. Each body section 62 is thus formed with an integrally extending lip 32 and half of the bridging section 54. Instead of the magnet sets of the FIGS. 2 to 4 embodiment, the stop blocks 28 can be in the form of magnets 64, thus inherently incorporating the magnetic force providing element configurations 24. As another alternative to the FIGS. 2 to 4 embodiment, the sidewalls 16 may themselves be composed of magnetically attracting material, thus inherently incorporating the magnetically attracting element configurations 26

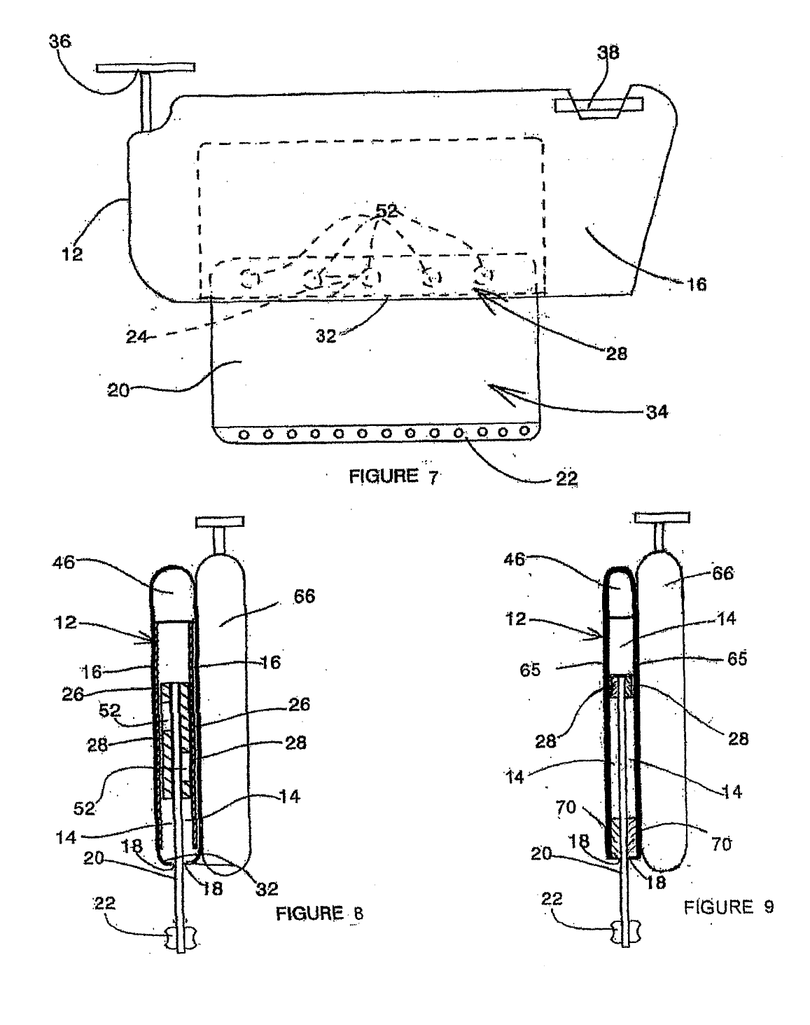

As illustrated in FIG. 7, instead of being multi-directionally adjustable, the visor equipment 10 can be arranged to be only linearly adjustable along a slot formed through the bottom edge 40 of the visor body 12. To stabilise the linear displacement of the sliding unit 34 of this embodiment, the stop blocks 28, as fitted with the magnet sets or otherwise rendered magnetic, can conveniently extend the full width of the cavity (as shown in broken lines). Stop blocks 28 are constrained from leaving cavity 14 by border providing lips 32. In yet a further embodiment with reference to FIG. 8, the equipment 10 can be by-way of an add-on accessory that is conventionally secured to a standard sun visor 66. Except for being by way of an add-on accessory the remainder of the equipment 10 of this embodiment corresponds with the FIGS. 1 to 7 embodiments. Similar parts thus carry the corresponding reference numbers.

Alternatively and as shown in FIG. 9, magnetic means in the form of strips 70 of flexible magnetic material can be fitted to the inner faces of sidewalls 16 close to their lower edges. The strips 70 are selected to exert adequate inter-attraction magnetic force to resistably pinch the panel 20 between them to hold it in a selected position while still permitting its manual adjustment.

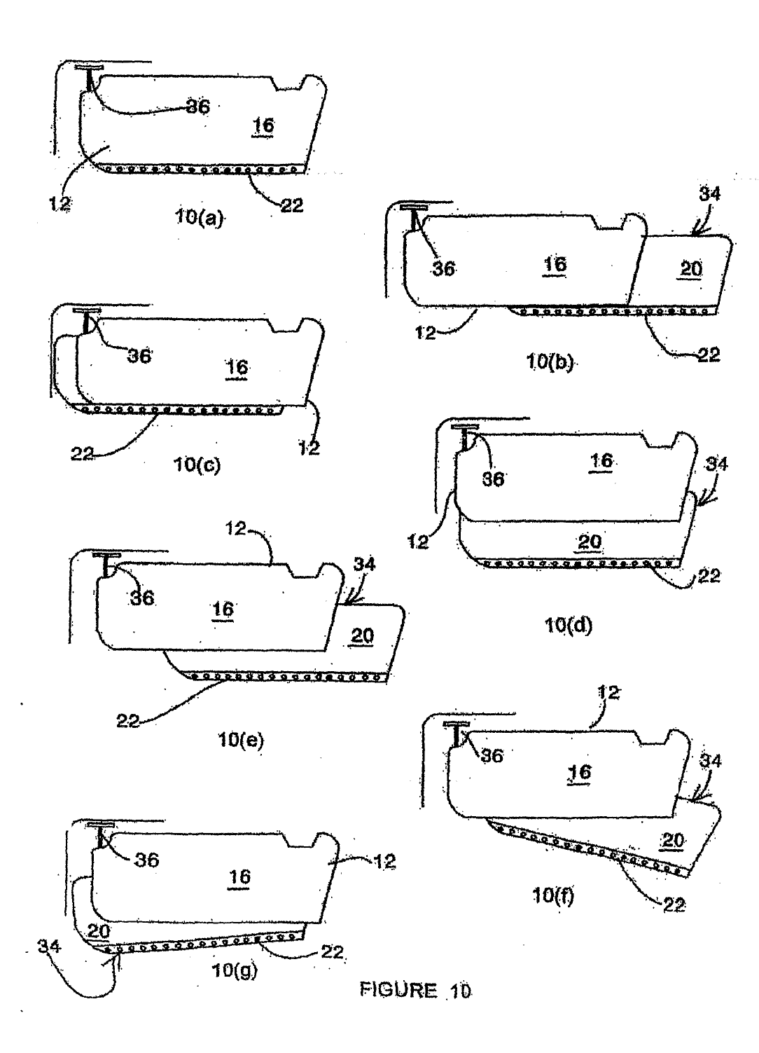

FIG. 10 shows some of the positions that can be taken up by the visor equipment 10 during multi-directionally adjustable use. While the equipment 10 is only shown in its windshield direct visual sunray exposure mitigating condition it will be appreciated that it will be equally applicable in the case of being swivelled into a side window sunray exposure mitigating condition. The equipment 10 can serve a conventional sun visor sunray exposure mitigating function as shown in FIG. 10(a). However, its extent of direct visual sunray exposure mitigation can be laterally extended by moving sliding unit 34 sideways by means of its gripping strips 22, as shown in FIGS. 10(b) and 10(c). The extent of lateral displacement is naturally limited by operation of the stop blocks 28. Being multi-directionally slidable, the sliding unit 34 can be displaced to broaden the overall sunray shielding width of the equipment as shown in FIG. 10(d) or to provide a sun shielding effect in a specific corner, as shown in FIG. 10(e). It can even be slanted as shown in FIGS. 10(f) and 10(g). It will be appreciated that the FIG. 7 embodiment of the equipment will only be adjustable unilaterally, in accordance with the shielding function illustrated in FIG. 10(d).

1. Vehicular employable sun visor type equipment for use in adjustably serving a direct visual sunray exposure mitigating function comprising
a visor body formed with an interior cavity extending between facing sidewall panels and which cavity is open to the environment by way of an aperture extending along at least the substantial extent of one edge of the body serving as lower edge once the equipment, as in use, performs a sun screening function even if by way of conventional sun visor equipment to which it is in such case attached, and
a displaceable visor function extender slidably fitting along the cavity in being at least linearly and by way of a manual action returnably slidable from an at least substantially fully hidden condition by way of a manual extender displacer that under such condition protrudes from the body to a condition of visor function supplementation of which the extent depends on the degree of extender egress from the body though up to a condition of maximum visor protrusion while the extender is constrained by a constraining arrangement from becoming released from the visor body;
characterised in that free displacement of the extender relative to the visor body is curtailed by a magnetic force that is exerted in the cavity and that is brought about by a magnetic layout that has the effect of at least one of causing a physical resistance to sliding, on the one hand, and a resistance to sliding that is brought about by the magnetic attraction effect between a magnetic facility found on one of the extender and the visor body and complementary magnetic means found on the other one of the extender and the visor body, on the other hand, while the magnetic layout is constituted to limit interference with extender displacement except for requiring the exertion of a manually applied manipulating force in achieving such displacement.

2. Vehicular employable sun visor type equipment as claimed in claim 1 in which the constraining arrangement comprises at least one slide extent inhibitor fitted to and being displaceable in conjunction with the extender while the visor body is formed with a border providing lip along the aperture that limits the inhibitor from passing outside the cavity resulting in the aperture being in the form of a slot.

3. Vehicular employable sun visor type equipment as claimed in claim 1 in which the magnetic layout at least comprises the magnetic facility and the complementary magnetic means.

4. Vehicular employable sun visor type equipment as claimed in claim 3 in which the magnetic facility is in the form of at least one magnetic force providing element configuration extending into the cavity while the complementary magnetic means is provided by at least one sheet of magnetically attracting material facing and magnetically interacting with the magnetic force providing element configuration.

5. Vehicular employable sun visor type equipment as claimed in claim 4 in which the at least one magnetic force providing element configuration is fitted to the extender, even if by way of the at least one slide extent inhibitor, while the at least one sheet of magnetically attracting material appropriately extends along the visor body.

6. Vehicular employable sun visor type equipment as claimed in claim 5 in which the at least one sheet of magnetically attracting material is provided by at least one of the sidewall panels as such being in the form of magnetically attracting material.

7. Vehicular employable sun visor type equipment as claimed in claim 5 that is fitted with a plurality of at least two magnetic force providing element configurations of which at least one extends from each of the opposite sides of the extender while the slide extent inhibitors, as thus extending from opposite sides of the extender, are located to limit the extender from becoming fully disengaged from the visor body.

8. Vehicular employable sun visor type equipment as claimed in claim 4 in which the interaction between the magnetic force providing element configuration and the magnetically attracting material includes the action of physical inter element attracting material contact.

9. Vehicular employable sun visor type equipment as claimed in claim 1 in which the aperture by means of which the interior spacing is open to the environment, in addition to extending at least the substantial extent of the edge of the body serving as lower edge once the equipment as in use performs a sun screening function, also extends along at least one of the lateral edges of the visor body while the latter is formed with an upper zone of firmness to promote its integrity especially but not exclusively in the case of the aperture also extending along both lateral edges, thereby enabling lateral as well as appropriate multi-directional sliding of the extender relative to the visor body.

10. Vehicular employable sun visor type equipment as claimed in claim 1 that is in the form of an independent sun visor for appropriate attachment in performing an adjustably direct visual sunray exposure mitigating function.

11. Vehicular employable sun visor type equipment as claimed in claim 1 that is in the form of a sun visor attachment in adjustably supplementing its sunray exposure mitigating function.

12. Vehicular employable sun visor type equipment as claimed in claim 1 in which the magnetic layout is formed to cause a physical resistance to sliding by way of magnetic means suitably fitted to the inner faces of sidewall panels to the effect of attracting one another sufficiently strongly to resistably grip and hold the extender in a selected position.

13. Vehicular employable sun visor type equipment as claimed in claim 12 in which the magnetic means is in the form of strips of magnetic material fitted to the inner faces of sidewall panels close to their lower edges.
